(19) United States
(12) Patent Application Publication
(10) Pub. No.: US 2020/0275520 A1
(43) Pub. Date: Aug. 27, 2020

(54) COMMUNICATION SYSTEM INCLUDING MULTIPLE PROTOCOLS AND INTEGRATED COMMUNICATION DEVICE

(71) Applicant: MING-TSUNG CHEN, Taipei City (TW)

(72) Inventor: MING-TSUNG CHEN, Taipei City (TW)

(21) Appl. No.: 16/281,830

(22) Filed: Feb. 21, 2019

(51) Int. Cl. H04W 80/04; H04W 4/80; H04W 88/08

(52) U.S. Cl. CPC H04W 80/045; H04W 84/18; H04W 88/08; H04W 4/80

(57) ABSTRACT

A communication system having multiple protocols includes a first integrated communication device and a second integrated communication device. The first integrated communication device includes a first intermediate communication circuit and a plurality of integrated communication modules, and the second integrated communication device includes a second intermediate communication circuit and a plurality of integrated communication modules. Second-type communication units of the integrated communication modules of the second integrated communication device respectively include a protocol. The first integrated communication device and the second integrated communication device communicate with each other through one of the protocols of the second-type communication units of the integrated communication modules of the first integrated communication device and the second integrated communication device.

### FIELD OF THE DISCLOSURE

The present disclosure relates to a communication system and a communication device, and more particularly to a communication system and a communication device including multiple protocols.

### BACKGROUND OF THE DISCLOSURE

In today's life, multiple protocols may be used at the same time, but since data cannot be transmitted between different protocols, it is not very convenient for users thereof. Moreover, for different transmission requirements, users using only one protocol for transmission cannot be afforded a satisfactory experience.

Therefore, providing a communication system that integrates multiple protocols has become an important issue in the industry.

### SUMMARY OF THE DISCLOSURE

In response to the above-referenced technical inadequacies, the present disclosure provides a communication system having multiple protocols. The communication system includes a first integrated communication device and a second integrated communication device. The first integrated communication device includes: a first intermediate communication circuit disposed in the first integrated communication device, and a plurality of integrated communication modules disposed in the first integrated communication device. The integrated communication modules of the first integrated communication device respectively include a first-type communication unit and a second-type communication unit, the first-type communication unit of each of the integrated communication modules communicate with the second-type communication unit of each of the integrated communication modules, the integrated communication modules of the first integrated communication device are electrically connected to the first intermediate communication circuit through the first-type communication units, respectively, the integrated communication modules of the first integrated communication device respectively communicate with each other through the first intermediate communication circuit, and the second-type communication units of the integrated communication modules of the first integrated communication device respectively include a protocol. The second integrated communication device includes a second intermediate communication circuit disposed in the second integrated communication device, and a plurality of integrated communication modules disposed in the second integrated communication device. The integrated communication modules of the second integrated communication device respectively include a first-type communication unit and a second-type communication unit, the first-type communication unit of each of the integrated communication modules communicate with the second-type communication unit of each of the integrated communication modules, the integrated communication modules of the second integrated communication device are electrically connected to the second intermediate communication circuit through the first-type communication units, respectively, the integrated communication modules of the second integrated communication device communicate with each through the second intermediate communication circuit, and the second-type communication units of the integrated communication modules of the second integrated communication device respectively include a protocol. The first integrated communication device and the second integrated communication device communicate with each other through one of the protocols of the second-type communication units of the integrated communication modules of the first integrated communication device and the second integrated communication device.

In certain embodiments, the present disclosure provides an integrated communication device. The integrated communication device includes a first communication module, a second communication module, and a third communication module. The first communication module includes a first Bluetooth communication unit and a first LoRa communication unit, the first Bluetooth communication unit communicating with the first LoRa communication unit. The second communication module includes a second Bluetooth communication unit and a second LoRa communication unit, the second Bluetooth communication unit communicating with the second LoRa communication unit. The third communication module includes a third Bluetooth communication unit and a third LoRa communication unit, the third Bluetooth communication unit communicating with the third LoRa communication unit. The first integrated communication device transmits a plurality of first LoRa communication signals to a second integrated communication device by the first Bluetooth communication unit and the first LoRa communication unit of the first communication module, the first integrated communication device receives a plurality of second LoRa communication signals transmitted from the second integrated communication device through the second Bluetooth communication unit and the second LoRa communication unit of the second communication module, and the third Bluetooth communication unit and the third LoRa communication unit of the third communication module. The first Bluetooth communication unit communicates with the second Bluetooth communication unit and the third Bluetooth communication unit.

Therefore, the multi-protocol communication system of the present disclosure can integrate communication units having a plurality of protocols in the same device, and communicate with each other by using the same first-type communication unit, and utilizes a plurality of dedicated downlink channels for quickly downloading data and uploading data using a dedicated uplink channel. Therefore, the transmission efficiency can be greatly improved. In addition, multiple coding tables are used to effectively process commands between different protocols, and the amount of data transmission can be reduced. Furthermore, the present disclosure can enable different types of signals to be processed by the appropriate communication methods for improving the processing efficiency by the communication connections between the first-type communication units of different integrated communication modules.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic diagram of a communication system of a multi-protocol according to an embodiment of the present disclosure.

FIG. 2 is a schematic diagram of an integrated communication module and an intermediary communication circuit according to an embodiment of the present disclosure.

FIG. 3 is a schematic diagram of an integrated communication system applied to a long-distance communication system based on an embodiment of the present disclosure.

FIG. 4 is a schematic diagram of the first integrated communication device of FIG. 3.

FIG. 5 is another schematic diagram of the first integrated communication device of FIG. 3.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

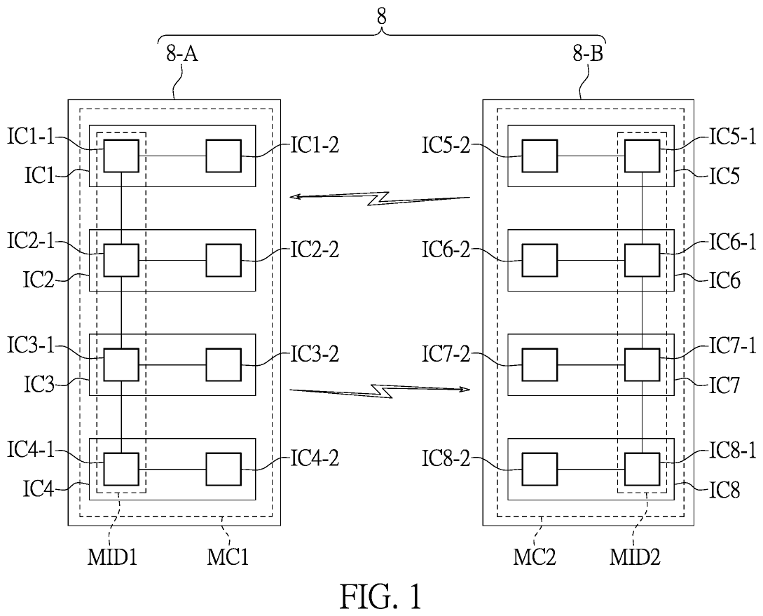

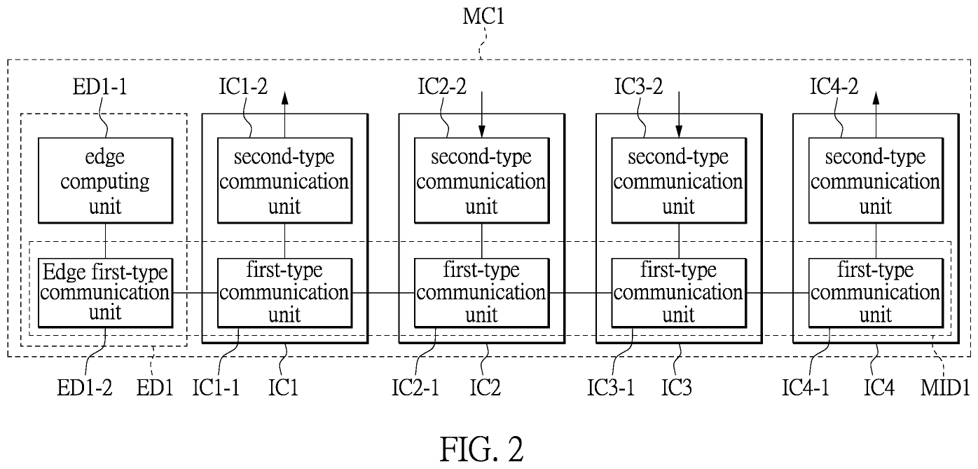

Referring to FIG. 1 and FIG. 2, FIG. 1 is a schematic diagram of a communication system of a multi-protocol according to an embodiment of the present disclosure. FIG. 2 is a schematic diagram of an integrated communication module and an intermediary communication circuit according to an embodiment of the present disclosure.

In the embodiment, a multi-protocol communication system 8 includes a first integrated communication device MC1 and a second integrated communication device MC2. In the embodiment, the first integrated communication device MC1 and the second integrated communication device MC2 are respectively disposed in a first area 8-A and a second area 8-B. A distance is defined between the first area 8-A and the second area 8-B.

The first integrated communication device MC1 includes a first intermediate communication circuit MID1 and a plurality of integrated communication modules. In the embodiment, the first integrated communication device MC1 includes four integrated communication modules, which are a first integrated communication module IC1, a second integrated communication module IC2, a third integrated communication module IC3, and a fourth integrated communication module IC4.

The second integrated communication device MC2 includes a second intermediate communication circuit MID2 and a plurality of integrated communication modules. In the embodiment, the second integrated communication device MC2 includes four integrated communication modules, which are a fifth integrated communication module IC5, a sixth integrated communication module IC6, a seventh integrated communication module IC7, and an eighth integrated communication module IC8.

The first intermediate communication circuit MID1 is disposed in the first integrated communication device MC1. The second intermediate communication circuit MID2 is disposed in the second integrated communication device MC2. In the embodiment, the first intermediate communication circuit MID1 and the second intermediate communication circuit MID2 are inter-integrated circuits (I2C).

The integrated communication modules IC1-IC4 of the first integrated communication device MC1 are disposed in the first integrated communication device MC1. The integrated communication modules IC1-IC4 of the second integrated communication device MC2 are disposed in the first integrated communication device MC1.

In the embodiment, the integrated communication modules IC1-IC4 of the first integrated communication device MC1 and the integrated communication modules IC5-IC8 of the second integrated communication device MC1 respectively include a first-type communication unit IC1-1˜IC8-1 and a second-type communication unit IC1-2˜IC8-2.

In the embodiment, the first-type communication units IC1-1˜4C8-1 are respectively connected to the second-type communication units IC1-2˜IC8-2.

The integrated communication modules IC1-IC4 of the first integrated communication device MC1 are electrically connected to the first intermediate communication circuit MID1 through the respective first-type communication units IC1-1˜IC4-1. The integrated communication modules IC1-IC4 of the first integrated communication device MC1 communicate with each other by the first intermediate communication circuit MID1.

The second-type communication units IC1-2˜1C4-2 of the integrated communication modules IC1-IC4 of the first integrated communication device MC1 respectively include a protocol. In other words, the second-type communication units IC1-2˜1C4-2 may be a LoRa communication unit, a Sigfox communication unit, a Wi-Fi communication unit, and an Internet of Things communication unit, respectively. In other words, the second-type communication units IC1-2˜IC4-2 of the integrated communication modules IC1-IC4 of the first integrated communication device MC1 may be communication units having the same protocol or having different protocols.

The integrated communication modules IC5-1C6 of the second integrated communication device MC2 are electrically connected to the second intermediate communication circuit MID2 through the respective first-type communication units IC5-1˜IC8-1. The integrated communication modules IC5-1C8 of the second integrated communication device MC2 are respectively connected by the second intermediate communication circuit MID2.

The second-type communication units IC5-2˜1C8-2 of the integrated communication modules IC5-1C8 of the second integrated communication device MC2 respectively include a protocol. In other words, the second-type communication units IC5-2˜IC8-2 can be a LoRa communication unit, a Sigfox communication unit, a Wi-Fi communication unit, and an Internet of Things communication unit (Internet of Things), respectively. In other words, the second-type communication units IC5-2˜IC8-2 of the integrated communication modules IC5-IC8 of the second integrated communication device MC2 may be the communication units having the same protocol or having different protocols.

The first integrated communication device MC1 and the second integrated communication device MC2 communicate with each other through one of the protocols of the integrated communication modules IC1-IC4 and the integrated communication modules IC5-IC8.

In other words, the first integrated communication device MC1 and the second integrated communication device MC2 can communicate with each other through the second-type communication units having the same protocol.

Each of the integrated communication modules IC1-IC8 of the first integrated communication device MC1 and the second integrated communication device MC2 includes a coding table.

Each of the integrated communication modules IC1-IC8 of the first integrated communication device MC1 and the second integrated communication device MC2 use a respective coding table thereof for encoding and decoding received signals or transmitted signals of the first-type communication units IC1-1˜IC8-1 and the second-type communication units IC1-2˜IC8-2.

In the embodiment, the first-type communication units IC1-1˜1C8-1 include a Bluetooth communication unit, a Wi-Fi communication unit, and a Zigbee communication unit. For example, when the first-type communication unit IC1-1˜IC8-1 is a Bluetooth communication unit, the integrated communication module ICI-IC8 needs to include a coding table that converts the Bluetooth protocol to a protocol of the second-type communication unit. .

For example, when the second-type communication unit is a LoRa communication unit, the integrated communication module IC1-IC8 needs to include a coding table that converts the instructions of the Bluetooth protocol into those of the LoRa protocol.

This coding table is an instruction compilation for the Bluetooth protocol and the LoRa protocol. In other words, the coding table integrates the instruction set and data with the same content in the complex Bluetooth protocol, and recompiles a new instruction set. The data transfer volume of this instruction set will be much smaller than the data transfer volume of the Bluetooth protocol. In addition, since a large amount of the transmission data is compressed, the LoRa communication unit can transmit less data while still transmitting or receiving the same data content.

Similarly, the coding table between other protocols is also produced as described above.

In the embodiment, the communication unit through which the first integrated communication device MC1 and the second integrated communication device MC2 communicate with each other at least includes an uplink channel and a downlink channel. In other embodiments, the first integrated communication device MC1 and the second integrated communication device MC2 may include more than two downlink channels to speed up the data downloading efficiency. In other embodiments, the first integrated communication device MC1 and the second integrated communication device MC2 may include the same number of multiple downlink channels and multiple uplink channels, for example, 3 uplink channels and 3 downlink channels.

In the embodiment, one of the integrated communication modules IC1-IC4 of the first integrated communication device MC1 is used only as an uplink channel for transmitting a plurality of communication signals to the second integrated communication device MC2. The other one of the integrated communication modules IC1-IC4 of the first integrated communication device MC1 is used only as a downlink channel for receiving a plurality of communication signals transmitted by the second integrated communication device MC2. In the embodiment, the first integrated communication module IC1 and the fourth integrated communication module IC4 are used as the uplink channels. The second integrated communication module IC2 and the third integrated communication module IC3 are used as the downlink channels.

The channels of the second integrated communication device MC2 can have the same configuration as that of the first integrated communication device MC1, and can be adjusted based on the actual requirements without being limited to the present disclosure.

In the embodiment, the first integrated communication device MC1 further includes an edge computing module ED1. The edge computing module ED1 is an instant and local computing module. In other words, the edge computing module ED1 receives instructions that need to be processed immediately, that are not transmitted in a long-distance or time-consuming manner to a cloud server or a remote server.

In the embodiment, the edge computing module ED1 includes an edge first-type communication unit ED1-1 and an edge computing unit ED1-2.

In the embodiment, the edge first-type communication unit ED1-1 communicates with the first-type communication units IC1-1˜IC4-1 of the integrated communication modules IC1-IC4 of the first integrated communication device MC1. The edge first-type communication unit ED1-1 is used for receiving a predetermined edge signal. In addition, the edge first-type communication unit ED1-1 can also be electrically connected to the first-type communication units IC1-1˜IC4-1 of the integrated communication modules IC1-IC4 of the first integrated communication device MC1 through the first intermediate communication circuit MID1. In the embodiment, the edge first-type communication unit ED1-1 is the same as the first-type communication units IC1-1˜IC4-1 of the integrated communication modules IC1-IC4.

The edge computing unit ED1-2 receives the predetermined edge signal received by the edge first-type communication unit ED1-1, and processes the predetermined edge signal to generate an edge response signal. The edge response signal is transmitted through the edge first-type communication unit ED1-1. In the embodiment, the edge first-type communication unit ED1-1 communicates with the edge computing unit ED1-2.

### Second Embodiment

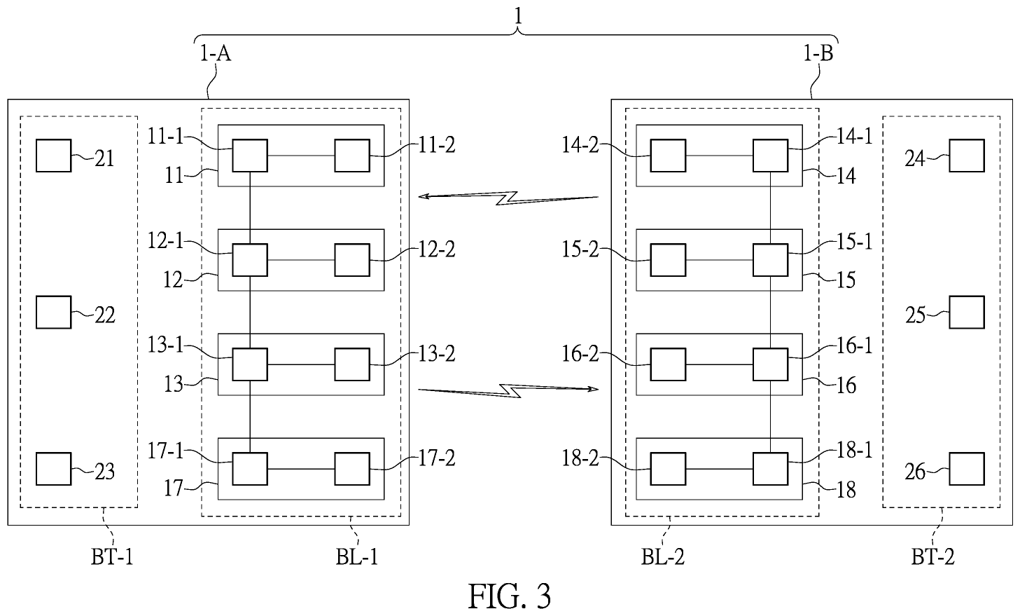

Referring to FIG. 3, FIG. 3 is a schematic diagram of an integrated communication system applied to a long-distance communication system based on an embodiment of the present disclosure.

In the embodiment, the long-distance communication system 1 is disposed in a first area 1-A and a second area 1-B. The first area 1-A and the second area 1-B are spaced apart by a first distance D. In the embodiment, the first distance D can be as long as 15 kilometers to 20 kilometers.

The long-distance communication system 1 includes a first integrated communication device BL-1 and a second integrated communication device BL-2. The first integrated communication device BL-1 is disposed in the first area 1-A. The second integrated communication device BL-2 is disposed in the second area 1-B.

The first integrated communication device BL-1 includes a first communication module 11, a second communication module 12, a third communication module 13, and a seventh communication module 17. The second integrated communication device BL-2 includes a fourth communication module 14, a fifth communication module 15, a sixth communication module 16, and an eighth communication module 18.

In the embodiment, the first communication module 11 and the seventh communication module 17 are used to transmit a plurality of first LoRa communication signals. The second communication module 12 and the third communication module 13 are used to receive a plurality of second LoRa communication signals transmitted by the second integrated communication device BL-2. The fourth communication module 14 and the eighth communication module 18 are used to transmit a plurality of second LoRa communication signals. The fifth communication module 15 and the sixth communication module 16 are used to receive a plurality of first LoRa communication signals transmitted by the first integrated communication device BL-1.

In the embodiment, the first communication module 11 and the seventh communication module 17 can be used to together transmit the first LoRa communication signals. In other embodiments, only the first communication module 11 is used to transmit the first LoRa communication signals for reducing cost. In other words, in the embodiment, the uplink channel (transmitting the LoRa communication signals) and the downlink channel (receiving the LoRa communication signals) of the LoRa communication signal are respectively processed by different communication modules. Moreover, in the embodiment, the number of uplink channels may be less than or equal to the number of downlink channels. In addition, the number of downlink channels (receiving LoRa communication signals) in the embodiment may be adjusted based on actual requirements, and is not limited to the present disclosure. In other words, the number of downlink channels can be between 2 and N, where N is infinite.

Similarly, the number of uplink channels and the number of downlink channels of the second integrated communication device BL-2 are also the same as those in the first integrated communication device BL-1, and further description thereof is omitted.

The communication modules 11-18 respectively include a first Bluetooth communication unit 11-1 to an eighth Bluetooth communication unit 18-1, and a first LoRa communication unit 11-2 to an eighth LoRa communication unit 18-2.

In the embodiment, the first Bluetooth communication unit 11-1 to the eighth Bluetooth communication unit 18-1 are respectively connected to the first LoRa communication unit 11-2 to the eighth LoRa communication unit 18-2.

In the embodiment, the Bluetooth communication unit and the LoRa communication unit of each communication module are connected by a Universal Asynchronous Receiver/Transmitter (UART).

The first integrated communication device BL-1 transmits a plurality of first LoRa communication signals to the second integrated communication device BL-2 through the first Bluetooth communication unit 11-1 and the first LoRa communication unit 11-2 of the first communication module 11.

The first integrated communication device BL-1 receives the second LoRa communication signals transmitted by the second integrated communication device BL-2 through the second Bluetooth communication unit 12-1, the second LoRa communication unit 12-2 and the third Bluetooth communication unit of the second communication module 12, and the third Bluetooth communication unit 13-1 and the third LoRa communication unit 13-2 of the third communication module 13.

In the embodiment, the second integrated communication device BL-2 transmits a plurality of second LoRa communication signals to the first integrated communication device BL-1 through the fourth Bluetooth communication unit 14-1, the fourth LoRa communication unit 14-2 of the fourth communication module 14, and the eighth Bluetooth communication unit 18-1 and the eighth LoRa communication unit 18-2 of the eighth communication module 18. In other embodiments, the second integrated communication device BL-2 may also transmit a plurality of second LoRa communication signals to the first integrated communication device BL-1 only through the fourth Bluetooth communication unit 14-1 and the fourth LoRa communication unit 14-2 of the fourth communication module 14.

The second integrated communication device BL-2 receives the first LoRa communication signals transmitted by the first integrated communication device BL-1 through the fifth Bluetooth communication unit 15-1, the fifth LoRa communication unit 15-2 of the fifth communication module 15, and the sixth Bluetooth communication unit 16 of the sixth communication module 16-1 and the sixth LoRa communication unit 16-2.

In the embodiment, the first Bluetooth communication unit 11-1 communicates with the second Bluetooth communication unit 12-1, the third Bluetooth communication unit 13-1, and the seventh Bluetooth communication unit 17-1. The fourth Bluetooth communication unit 14-1 communicates with the fifth Bluetooth communication unit 15-1, the sixth Bluetooth communication unit 16-1, and the eighth Bluetooth communication unit 18-1. The Bluetooth communication units of each module of the first integrated communication devices BL-1 communicate with each other through an inter-integrated circuit (I2C).

The first integrated communication device BL-1 includes a first coding table, and the second integrated communication device BL-2 includes a second coding table. The first coding table and the second coding table are the same coding table. In the embodiment, the first LoRa communication signal transmitted by the first integrated communication device BL-1 and the second LoRa communication signal transmitted by the second integrated communication device BL-2 are respectively converted through the first coding table and the second coding table.

In the embodiment, the first coding table and the second coding table are instruction compilations for the Bluetooth transmission protocol and the LoRa transmission protocol. In other words, the first coding table and the second coding table integrate the instruction set and data with the same content in the complicated Bluetooth transmission protocol, and recompile a new instruction set. The data transfer volume of this instruction set will be much smaller than that of the Bluetooth protocol. In addition, since a large amount of the transmission data is compressed, the LoRa communication unit can transmit less data while still transmitting or receiving the same data content.

When the signals are received, the first integrated communication device BL-1 converts the received second LoRa communication signals into a plurality of second Bluetooth signals based on the first coding table. A first compression ratio is defined between the converted data amount of the second Bluetooth signals and the data amount of the second LoRa communication signals. The second integrated communication device BL-2 converts the received first LoRa communication signals into a plurality of first Bluetooth signals based on the second coding table. At this time, the data amount of the first Bluetooth signals and the data amount of the first LoRa communication signals have a second compression ratio. Since the first coding table and the second coding table used by the first integrated communication device BL-1 and the second integrated communication device BL-2 are the same, the first compression ratio is equal to the second compression ratio.

When the signals are transmitted, the first integrated communication device BL-1 converts the third Bluetooth signals into a plurality of first LoRa communication signals based on the first coding table for transmission. A third compression ratio is defined between the data amount of the third Bluetooth signals and the data amount of the first LoRa communication signals. The second integrated communication device BL-2 converts the fourth Bluetooth signals into a plurality of second LoRa communication signals based on the second encoding table. A fourth compression ratio is defined between between the data amount of the fourth Bluetooth signals and the data amount of the second LoRa communication signals. Since the first coding table and the second coding table used by the first integrated communication device BL-1 and the second integrated communication device BL-2 are the same, the third compression ratio is equal to the fourth compression ratio.

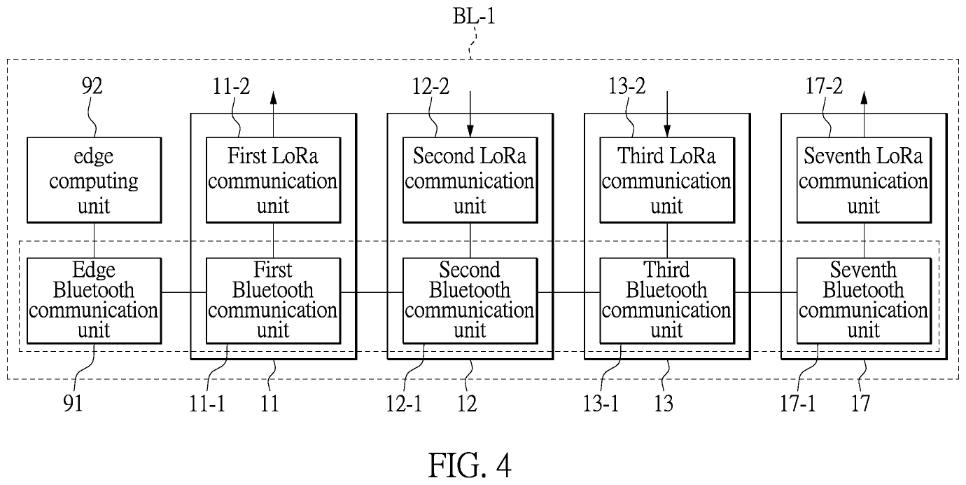

Referring to FIG. 4, the first integrated communication device BL-1 further includes an edge Bluetooth communication unit 91 and an edge computing unit 92.

In the embodiment, the edge Bluetooth communication unit 91 also communicates with the first Bluetooth communication unit 11-1, the second Bluetooth communication unit 12-1, the third Bluetooth communication unit 13-1, and the seventh Bluetooth communication unit 17-1.

The edge Bluetooth communication unit 91 is configured to receive a predetermined edge signal. In other words, a control signal with certain conditions may not be suitable for long-distance transmission to the cloud server for processing. Therefore, the edge computing unit 92 is locally implemented for instantly processing these predetermined edge signals to improve the efficiency.

Therefore, in the embodiment, the edge computing unit 92 receives the predetermined edge signal received by the edge Bluetooth communication unit 91, and computes the predetermined edge signal to generate an edge response signal. The edge response signal is transmitted through the first edge Bluetooth communication unit 91.

In the embodiment, the second integrated communication device BL-2 may also include the edge computing unit 92 and the edge Bluetooth communication unit 91 having the same structure and function as the first integrated communication device BL-1, which may be implemented based on actual requirements and is not limited to the present disclosure.

In the embodiment, the long-distance communication system 1 further includes a first indoor Bluetooth communication unit group BT-1. The first indoor Bluetooth communication unit group BT-1 includes a plurality of first indoor Bluetooth communication units 21-23, which are respectively disposed in the first area 1-A. The first indoor Bluetooth communication units 21-23 communicate with the first integrated communication device BL-1. In the embodiment, the number of the first indoor Bluetooth communication units can be adjusted based on actual requirements, and is not limited to the present disclosure.

In addition, the long-distance communication system 1 further includes a second indoor Bluetooth communication unit group BT-2. The second indoor Bluetooth communication unit group BT-2 includes a plurality of second indoor Bluetooth communication units 24-26, which are respectively disposed in the second area 1-B. The second indoor Bluetooth communication units 24-26 communicate with the second integrated communication device BL-2. In the embodiment, the number of the second indoor Bluetooth communication units can be adjusted based on actual requirements, and is not limited to the present disclosure.

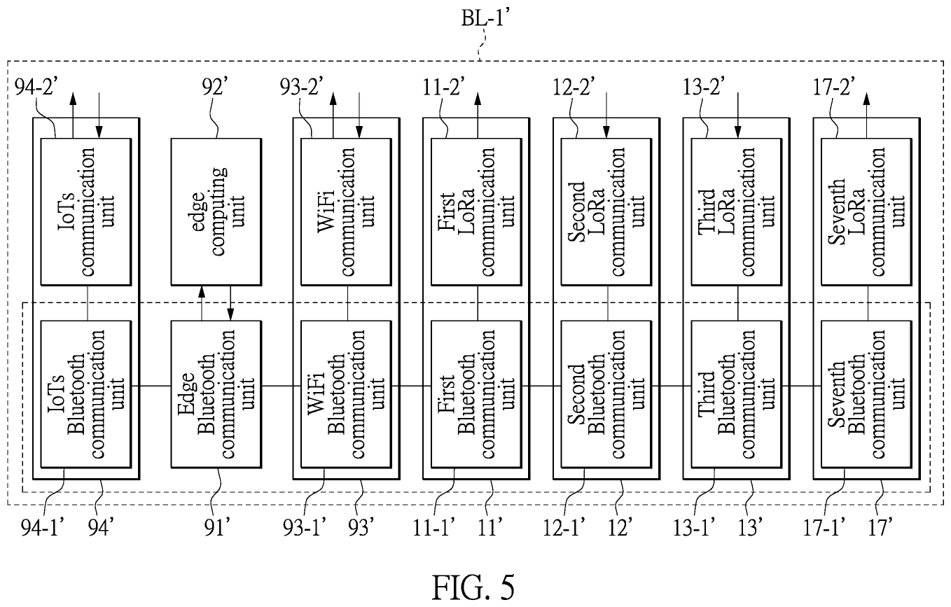

Referring to FIG. 5, the structure of the first integrated communication device BL-1′ in FIG. 5 is substantially similar to that of the first integrated communication device BL-1 in FIG. 4. The main difference is that the first integrated communication device BL-1′ further includes a Wi-Fi communication module 93′ and an IoT communication module 94′. In other words, the first communication module 11′, the second communication module 12′, the third communication module 13′, the seventh communication module 17′, the edge Bluetooth communication unit 91′, and the edge computing unit 92′ of the first integrated communication device BL-1′ are similar to the first communication module 11, the second communication module 12, the third communication module 13, the seventh communication module 17, and the edge Bluetooth communication unit 91 and the edge computing unit 92 of the first integrated communication device BL-1, and will not be further described herein.

In the embodiment, the Wi-Fi communication module 93′ includes a Wi-Fi communication unit 93-2′ and a Wi-Fi Bluetooth communication unit 93-1′. The Wi-Fi Bluetooth communication unit 93-1′ communicates with the first Bluetooth communication unit 11-1′, the second Bluetooth communication unit 12-1′, the third Bluetooth communication unit 13-1′, the seventh Bluetooth communication unit 17-1′, and the edge Bluetooth communication unit 91′.

In the embodiment, the Wi-Fi communication unit 93-2′ of the Wi-Fi communication module 93′ communicates with an Internet network, and has a large bandwidth which can be used for transmitting a large amount of data.

In addition, the Internet of Things communication module 94′ includes an Internet of Things communication unit 94-2′ and an Internet of Things Bluetooth communication unit 94-1′.

The Internet of Things Bluetooth communication unit 94-1′ communicates with the first Bluetooth communication unit 11-1′, the second Bluetooth communication unit 12-1′, the third Bluetooth communication unit 13-1′, and the seventh Bluetooth communication unit 17-1′, the edge Bluetooth communication unit 91′, and the Wi-Fi Bluetooth communication unit 93-1′.

In the embodiment, the Internet of Things communication unit 93-2′ can communicate with a cloud server (not shown). Therefore, the Internet of Things communication unit 93-2′ can be used to transmit or receive an Internet of Things control signal.

In conclusion, the multi-protocol communication system of the present disclosure can integrate communication units having a plurality of protocols in the same device that can communicate with each other by using the same first-type communication unit, and utilizes a plurality of dedicated downlink channels for quickly downloading data and a dedicated uplink channel for quickly uploading data. Therefore, the transmission efficiency can be greatly improved. In addition, multiple coding tables are used to effectively process commands between different protocols, and the amount of data transmission can be reduced. Furthermore, the present disclosure can enable different types of signals to be processed through appropriate communication methods for improving the processing efficiency by the communication between the first-type communication units of different integrated communication modules.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A communication system having multiple protocols, comprising:
a first integrated communication device including:
a first intermediate communication circuit disposed in the first integrated communication device; and
a plurality of integrated communication modules disposed in the first integrated communication device, the integrated communication modules of the first integrated communication device respectively including a first-type communication unit and a second-type communication unit, the first-type communication unit of each of the integrated communication modules communicating with the second-type communication unit of each of the integrated communication modules, the integrated communication module of the first integrated communication device electrically connected to the first intermediate communication circuit through the first-type communication units, respectively, the integrated communication modules of the first integrated communication device respectively communicating with each other through the first intermediate communication circuit, the second-type communication units of the integrated communication modules of the first integrated communication device respectively including a protocol; and
a second integrated communication device including:
a second intermediate communication circuit disposed in the second integrated communication device; and
a plurality of integrated communication modules disposed in the second integrated communication device, the integrated communication modules of the second integrated communication device respectively including a first-type communication unit and a second-type communication unit, the first-type communication unit of each of the integrated communication modules communicating with the second-type communication unit of each of the integrated communication modules, the integrated communication modules of the second integrated communication device electrically connected to the second intermediate communication circuit through the first-type communication units, respectively, the integrated communication modules of the second integrated communication device communicating with each through the second intermediate communication circuit, the second-type communication units of the integrated communication modules of the second integrated communication device respectively including a protocol;
wherein the first integrated communication device and the second integrated communication device communicate with each other through one of the protocols of the second-type communication units of the integrated communication modules of the first integrated communication device and the second integrated communication device.

2. The communication system of claim 1, wherein the integrated communication modules of the first integrated communication device and the second integrated communication device respectively include a coding table, the integrated communication modules of the first integrated communication device and the second integrated communication device respectively use the coding table for encoding and decoding received signals or transmitted signals of the first-type communication units and the second-type communication units.

3. The communication system of claim 2, wherein two of the integrated communication modules of the first integrated communication device are used as an uplink channel for transmitting a plurality of communication signals to the second integrated communication device and a downlink channel for receiving a plurality of communication signals transmitted by the second integrated communication device.

4. The communication system of claim 1, wherein the first integrated communication device further includes:
an edge computing module, including:
an edge first-type communication unit communicating with the first-type communication units of the integrated communication modules for receiving a predetermined edge signal; and
an edge computing unit receiving the predetermined edge signal received by the edge first-type communication unit, and computing the predetermined edge signal to generate an edge response signal, the edge response signal being transmitted by the edge first-type communication unit, the edge first-type communication unit communicating with the edge computing unit.

5. An integrated communication device, comprising:
a first communication module including a first Bluetooth communication unit and a first LoRa communication unit, the first Bluetooth communication unit communicating with the first LoRa communication unit;
a second communication module including a second Bluetooth communication unit and a second LoRa communication unit, the second Bluetooth communication unit communicating with the second LoRa communication unit;
a third communication module including a third Bluetooth communication unit and a third LoRa communication unit, the third Bluetooth communication unit communicating with the third LoRa communication unit;
wherein the first integrated communication device transmits a plurality of first LoRa communication signals to a second integrated communication device by the first Bluetooth communication unit and the first LoRa communication unit of the first communication module, the first integrated communication device receives a plurality of second LoRa communication signals transmitted from the second integrated communication device through the second Bluetooth communication unit and the second LoRa communication unit of the second communication module, and the third Bluetooth communication unit and the third LoRa communication unit of the third communication module;
wherein the first Bluetooth communication unit communicates with the second Bluetooth communication unit and the third Bluetooth communication unit.

6. The integrated communication device of claim 5, further comprising:
a seventh communication module, including a seventh LoRa communication unit and a seventh Bluetooth communication unit, wherein the seventh Bluetooth communication unit is electrically connected to the first Bluetooth communication unit, the second Bluetooth communication unit, and the third Bluetooth communication unit and the first edge Bluetooth communication unit, wherein the seventh Bluetooth communication unit communicates with the seventh LoRa communication unit;
wherein the seventh LoRa communication unit and the first LoRa communication unit together transmit the first LoRa communication signals to the second integrated communication device.

7. The integrated communication device of claim 6, further comprising:
a Wi-Fi communication module, the Wi-Fi communication module including a Wi-Fi communication unit and a Wi-Fi Bluetooth communication unit;
an Internet of Things communication module, the Internet of Things communication module including an Internet of Things communication unit and an Internet of Things Bluetooth communication unit, and an edge Bluetooth communication unit communicating the first Bluetooth communication unit, the second Bluetooth communication unit, and the third Bluetooth communication unit for receiving a predetermined edge signal;
an edge computing unit receiving the predetermined edge signal received by the edge Bluetooth communication unit, and processing the predetermined edge signal to generate an edge response signal, the edge response signal being transmitted by the edge Bluetooth communication unit, the edge Bluetooth communication unit communicating with the edge computing unit;
wherein the Wi-Fi Bluetooth communication unit communicates with the first Bluetooth communication unit, the second Bluetooth communication unit, the third Bluetooth communication unit, the seventh Bluetooth communication unit, and the edge Bluetooth communication unit;
wherein the Wi-Fi communication unit of the Wi-Fi communication module is used to transmit a large amount of data;
wherein the Internet of Things Bluetooth communication unit communicates with the first Bluetooth communication unit, the second Bluetooth communication unit, the third Bluetooth communication unit, the seventh Bluetooth communication unit, the edge Bluetooth communication unit, and the Wi-Fi Bluetooth communication unit;
wherein the Internet of Things communication unit is used to transmit or receive an Internet of Things control signal.
